(19) United States
(12) Patent Application Publication
(10) Pub. No.: US 2015/0356521 A1
(43) Pub. Date: Dec. 10, 2015

(54) System, Method, And Apparatus For Oilfield Equipment Prognostics And Health Management

(71) Applicant: Schlumberger Technology Corporation, Sugar Land, TX (US)

(72) Inventors: Garud Bindiganavale Sridhar, Sugar Land, TX (US); Michael Wedge, Sugar Land, TX (US); Dzung Le, Stafford, TX (US); Sarmad Adnan, Sugar Land, TX (US); Iskandar Wijaya, Sugar Land, TX (US); Orlando Defreitas, Richmond, TX (US); Radovan Rolovic, Sugar Land, TX (US); Sandra Aldana, Houston, TX (US); Luis Antonio Rodriguez, Sugar Land, TX (US)

(21) Appl. No.: 14/828,833

(22) Filed: Aug. 18, 2015

Related U.S. Application Data
(63) Continuation of application No. 13/997,970, now abandoned.
(60) Provisional application No. 61/398,753, filed on Jun. 30, 2010.

(51) Int. Cl. G06Q 10/00; E21B 49/08; E21B 47/00; E21B 17/00; E21B 17/20; E21B 47/06; E21B 34/06

(52) U.S. Cl. CPC G06Q 10/20; E21B 47/06; E21B 49/081; E21B 34/06; E21B 17/00; E21B 17/20; E21B 47/00

(57) ABSTRACT

A system for oilfield equipment asset utilization improvement includes a number of units of oilfield equipment, the units of oilfield equipment having a common equipment type. The system further includes a controller having an equipment confidence module that interprets a condition value corresponding to each of the units of oilfield equipment, a job requirement module that interprets a performance requirement for an oil field procedure, and an equipment planning module that selects a set of units from the number of units of oilfield equipment in response to the performance requirement for the oilfield procedure and the condition value corresponding to each of the units of oilfield equipment. The equipment planning module selects the set of units such that a procedure success confidence value exceeds a completion assurance threshold.

### BACKGROUND

Oilfield applications utilize a variety of types of equipment on a location. The determination of appropriate maintenance schedules and prediction of equipment failures is an ongoing challenge. The failure of equipment on a location can have tremendous costs, causing a failure of a treatment or a well, and idling expensive equipment and crews while awaiting replacement equipment. The cost of equipment failures, and the difficulty in delivering replacement equipment is even greater in offshore applications. Current systems to manage maintenance and prediction of equipment failures exist but suffer from several drawbacks.

One currently available system includes providing redundancy and extra equipment at a location. Redundant equipment increases the cost of a treatment, increases the total capital required to maintain a given level of operating capacity, and is not an optimal solution where space at the location is at a premium—for example offshore or in environmentally sensitive areas.

Another currently available system includes determining an abnormal condition in a particular unit of equipment, and/or predicting when an abnormal condition is about to occur in a given unit of equipment. A further embodiment of a currently available system predicts a process specific maintenance schedule. A limitation of such systems is that a process specific maintenance schedule is not tailored to a specific piece of equipment, for example as the equipment ages or experiences varying duty cycles due to utilization in disparate job types. Further, determining an abnormal condition in a specific unit of equipment merely determines whether a given unit of equipment is available or will be available. However, such determinations do not allow for increased asset utilization by accounting for interactions between units of equipment, or through adaptation of maintenance responses to improve the utilization of the particular unit of equipment. Therefore, further technological developments are desirable in this area.

### SUMMARY

One embodiment is a unique apparatus for adjusting an equipment maintenance schedule. Another embodiment is a unique apparatus for improving asset utilization. Yet another embodiment is a method for performing a prognostic maintenance preparation step. Further embodiments, forms, objects, features, advantages, aspects, and benefits shall become apparent from the following description and drawings.

### BRIEF DESCRIPTION OF THE DRAWINGS

FIG. 1 is a schematic block diagram of an exemplary controller for updating a maintenance schedule of a oilfield equipment unit.

FIG. 2 is a schematic block diagram of an exemplary controller for maximizing oilfield equipment asset utilization.

FIG. 3 is a schematic block diagram of an exemplary controller for performing a maintenance preparation step.

FIG. 4 is a schematic diagram of a system including a plurality of monitored variables.

FIG. 5 is a schematic diagram of a prognostics and health management system.

FIG. 6 is a schematic diagram of an alternate embodiment of a prognostics and health management system.

FIG. 7 depicts illustrative data of T² statistic versus a sequence of observation points.

FIG. 8 depicts a T² statistic determined from a system including a plurality of monitored variables.

FIG. 9 depicts illustrative data of unit Euclidean distance from a mean.

FIG. 10 depicts illustrative data of Euclidean and Mahalanobis distance from a mean.

FIG. 11 depicts illustrative data showing average permeability readings from a plurality of fluid analysis devices versus time.

FIG. 12 depicts illustrative data showing a T² statistic for one of the fluid analysis devices versus time.

FIG. 13 depicts the illustrative data showing the T² statistic for the one of the fluid analysis device versus time, with outlier data removed.

FIG. 14 depicts illustrative data showing the T² statistic for a second one of the fluid analysis devices versus time.

FIG. 15 depicts illustrative data showing the T² statistic for a third one of the fluid analysis devices versus time.

FIG. 16 depicts an illustrative system for providing real-time equipment health and maintenance preparation for an oilfield equipment unit.

FIG. 17 depicts illustrative pressure data versus operating time.

FIG. 18 depicts T² statistic values corresponding to the illustrative data of FIG. 17.

FIG. 19 depicts an exemplary Pareto chart depicting the most significant sensor readings based on a T² decomposition of the illustrative data of FIG. 17.

FIG. 20 depicts an exemplary unsquared variance chart for the illustrative data of FIG. 17, determined from the principal components identified in FIG. 19.

### DESCRIPTION OF THE ILLUSTRATIVE EMBODIMENTS

For the purposes of promoting an understanding of the principles of described embodiments herein, reference will now be made to the embodiments illustrated in the drawings and specific language will be used to describe the same. It will nevertheless be understood that no limitation of the scope of the contemplated embodiments is thereby intended, any alterations and further modifications in the illustrated embodiments, and any further applications of the principles of the described embodiments as illustrated therein as would normally occur to one skilled in the art to which the described embodiments relate are contemplated herein.

It should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. Wherever numerical descriptions are provided, each numerical value should be read once as modified by the term “about” (unless already expressly so modified), and then read again as not so modified unless otherwise indicated in context. It should also be understood that wherever a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide information related to the present disclosure and may not constitute prior art.

Embodiments disclosed herein are generally related to a health monitoring system (i.e., Prognostics and Health Management (PHM)) for predicting future reliability of equipment(s) in the field of oil and gas exploration and production.

Equipment used in well services/wireline operations often includes sensors that are utilized to measure various parameters. These parameters provide job related information or equipment performance information. For example, on a stimulation fracturing pump unit, there are pressure and temperature sensors on the engine and transmission that provide power train performance information, and there are pressure sensors on the fluid end that provide job related information. These sensors are strategically located to evaluate flow rate, temperature, pressure, blending rate, density of fluid, just to name a few.

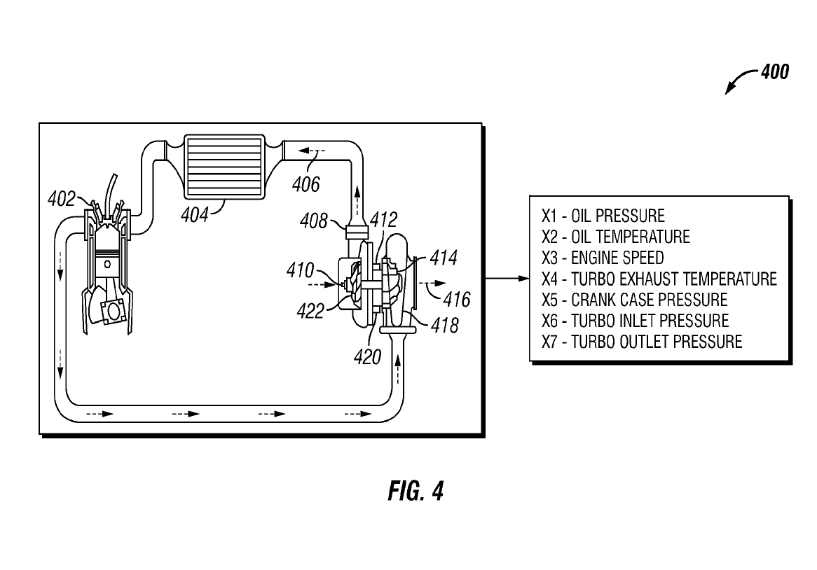

Referencing FIG. 4, an exemplary engine system 400 includes at least one engine cylinder 402, a charge air cooler 404, a compressed air flow 406, a compressor 408, an ambient air inlet 410, a turbocharger outlet 412, a turbine wheel 414, an exhaust gas discharge 416, a wastegate 418 for the turbocharger, an oil outlet 420 for the turbocharger lubrication system, and a compressor wheel 422. The illustrated parts of the system are exemplary and non-limiting. An exemplary oilfield sensor system 400 measures a series of parameters, such as X1—oil pressure, X2—oil temperature, X3—engine speed, X4—turbo exhaust temperature, X5—crank case pressure, X6—turbo inlet pressure, and X7—turbo outlet pressure, and so on. More examples of oilfield sensor systems are disclosed in co-assigned U.S. patent application Ser. Nos. 11/312,124 and 11/550,202, the contents of which are incorporated herein by reference in their entireties for all purposes.

According to some embodiments of the current application, there is provided a system for predicting the future reliability of oilfield equipment(s) by assessing the extent of deviation or degradation of equipment(s) from its/their expected normal operating conditions. This system can perform real time monitoring of the health conditions of the equipment(s) to evaluate its/their actual life-cycle conditions, to determine the initiation of failure, determine the level of maintenance required of the equipment(s). The system of the current application also helps to validate the operating conditions of the equipment(s) and to mitigate system risks.

Real time prognostic health management of equipment can be accomplished by a fully integrated PHM system. The data is fed into an analyzer, such as a computer system, which in turn extrapolates the captured data and compares it as a function of historical data. This extrapolation can predict the total remaining life before next maintenance or failure. Correlated data (parameter and vibration) can be used to reach more accurate prediction and an increased confidence level about the utilization of an asset. Incorporating this integrated PHM system into oilfield operations can optimize preventive maintenance schedules and improve asset utilization.

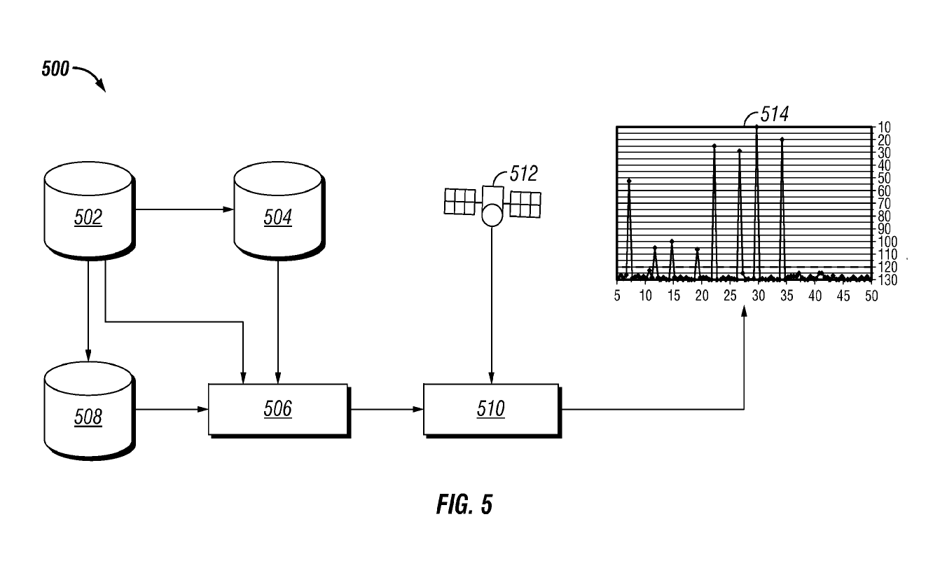

Referencing FIG. 5, an exemplary system 500 to establish normal (healthy) baseline data for a unit of equipment is illustrated. Field data 502 collected for normal (good, healthy, etc.) operating equipment 504 is utilized to establish the region of good operational data 506. In certain embodiments, field data 502 from a failed (bad, unhealthy, intentionally improperly operating, etc.) equipment 508 is used to validate, calibrate, and/or set a baseline for the good operational data 506. The accumulated good operational data 506 calibrated from the good equipment 504 and the bad equipment 508 may be stored as a good historical data set 510. New data 512 taken from real time operations of equipment is compared to the good historical data set 510. The new data 512 may be evaluated on location, or may be transmitted remotely for evaluation. The comparison of the new data 512 with the good historical data set 510 provides a final interpretation 514 of the condition of the equipment that provided the new data 512. The final interpretation 514 of the data may be determined by a distance from the mean of the good historical data set 510, which may be a Euclidean mean (e.g. all dimensions or channels weighted equally) or a Mahalanobis distance (e.g. dimensions or channels weighted according to correlation value—more predictive parameters are given greater weight) or by other mean-distance parameter understood in the art.

The final interpretation on the newly arrived data can be used by the appropriate personnel, either on-site or off-site of an oilfield operation, as guidance for proper actions. The newly arrived data can be further streamed to the field data 502 so that the field data 502 represents a continuous accumulation of new data from operations in the oilfield. Equipment that has provided new data 512 may be deemed to be part of the good equipment 504 or the bad equipment 508 to add to the data used for the good historical data set 510.

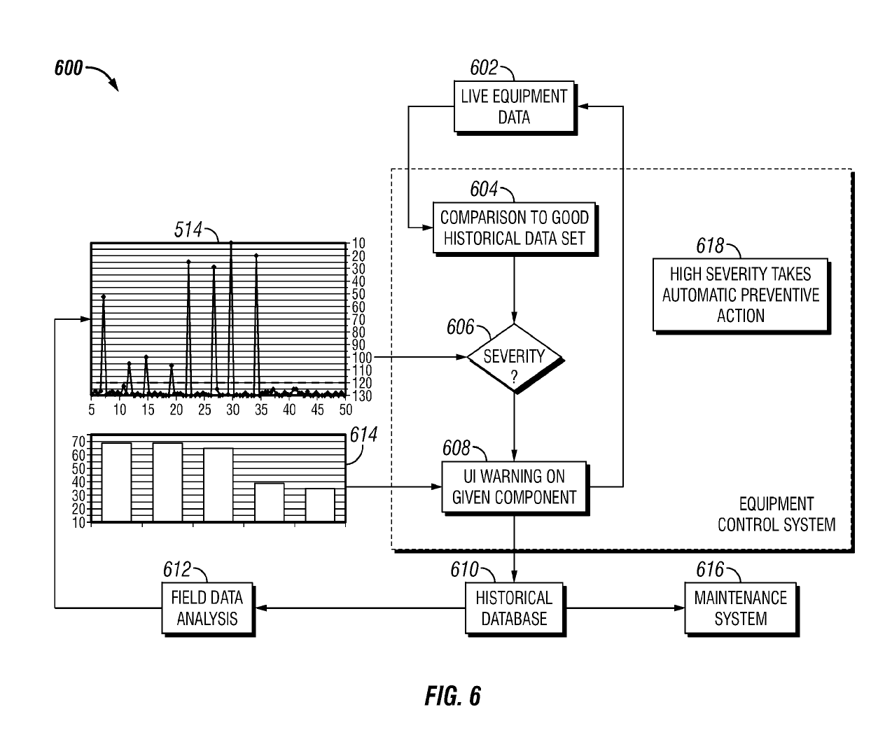

Referencing FIG. 6, an exemplary system 600 to utilize established historical data is illustrated. Live equipment data 602 is determined in real-time from an operating unit of equipment. The live equipment data 602 is compared to a good historical data set 604, and a severity 606 of any potential failure is determined according to the comparison and a previous iteration of a final interpretation 514 for the equipment. If the severity 606 is high, the system 600 may include actions 618 that occur automatically to prevent a sever failure—for example a pump may shut down, a fluid analysis unit may signal a failure indicator, or other operation understood in the art may occur.

In certain embodiments, where a failure or imminent failure is present, but the severity 606 is not sufficient for the automatic action 618, a user interface warning 608 on the unit of equipment may be activated or otherwise presented. The system 600 includes storing ongoing data into the historical database 610. The historical database 610 is provided to a maintenance system 616 with the current state of the equipment, and the historical database 610 may further be utilized in a field data analysis 612 to update the final interpretation 514 of the equipment.

In another example, depending on the severity 606 of the analysis, either a warning 608 would be presented on the UI to the operators showing the component in question and the reasoning behind the alarm (based on a decomposition of the data points, look at pareto analysis 614) or if severe enough would have the system act 618 upon the given component or equipment automatically. The data would be streamed to a database that feeds both the maintenance system with the current state of the equipment and also the field data being used to further enhance the interpretation.

Therefore, the system 600 of the current application is capable of capturing data from one or more units of equipment, analyzing the data, and transmitting the analyses to appropriate personnel automatically. The system 600 minimizes the need for subjective human interference to determine the need for preventive maintenance and mitigate catastrophic failures.

Advanced statistical techniques such as Mahalanobis-Taguchi System (MTS) and/or Multivariate Statistical Process Control (MVSPC) can be used in embodiments of the current application. Mahalanobis-Taguchi System (MTS) is a pattern information technology. It has been used in different diagnostic applications such as medical diagnosis, face/voice recognition, inspection systems, etc. Quantitative decisions can be made by constructing a multivariate measurement scale using data analytic methods.

In a typical MTS analysis, Mahalanobis Distance (a multivariate measure, hereinafter MD) is calculated to measure the degree of abnormality of patterns, and the principles of Taguchi methods are implemented to evaluate the accuracy of prediction based on the scale constructed. The MD takes into consideration the correlations between multiple variables. While a Euclidean distance treats all determinative parameters in the system equally, the MD gives greater weight to highly correlative parameters.

An exemplary MD is provided by: Zᵢ C⁻¹ Zᵢ; where Zᵢ is standardized vector of Xᵢ (i=1 . . . k), C is the correlation matrix, and Z′ is the transpose of the vector Z. The scaled MD is obtained by: (1/k) Z′ᵢ C⁻¹ Zᵢ; where k is the number of variables. More information about the Mahalanobis-Taguchi System (MTS) can be found in The Mahalanobis-Taguchi Strategy: A Pattern Technology System, G. Taguchi, et al., Wiley & Sons, Inc. (2002), the entire contents of which are incorporated by reference into the current application for all purposes.

One feature of MTS is to identify those sensors/parameters that are more useful in detecting abnormalities. Hence, sensors/parameters that do not contribute significantly to the detection of equipment abnormalities can be eliminated to reduce the total number of variables the prognostic health system has to track. In some embodiments, a Taguchi Orthogonal Array L12 (211) can be used to determine the signal to noise (S/N) ratio and S/N ratio gain of each sensor/parameter. The larger the S/N ratio, the greater the importance of the sensor/parameter. Moreover, a positive S/N ratio gain indicates the sensor/parameter is important in determining abnormalities of an equipment; a negative S/N ratio gain indicates a less useful sensor/parameter in determining abnormalities of the equipment.

An example is shown in Table 1 below.

TABLE 1
MTS Optimization

| Variable | Level 1 | Level 2 | Gain | |
|---|---|---|---|---|
| X1 | | | 0.805 | Level 1: On |
| X2 | | | −0.270 | Level 2: Off |
| . . . | | | | |
| . . . | | | | |
| . . . | | | | |
| X7 | −1.440 | −0.684 | −0.756 | |
| X8 | −0.137 | −1.987 | 1.850 | |

Multivariate Statistical Process Control (MVSPC) is a probabilistic method and is based on the application of Hotelling's T² statistic, which also takes into consideration the correlations between multiple variables. Typically, an MVSPC process consists of two phases: Phase 1; Obtain a baseline control limit based on a reference sample. The reference sample is the data collected from a known normal condition. Phase 2; Collect data from the current production (i.e. the operational phase), compute the appropriate T² statistics, and then compare them with the control limit.

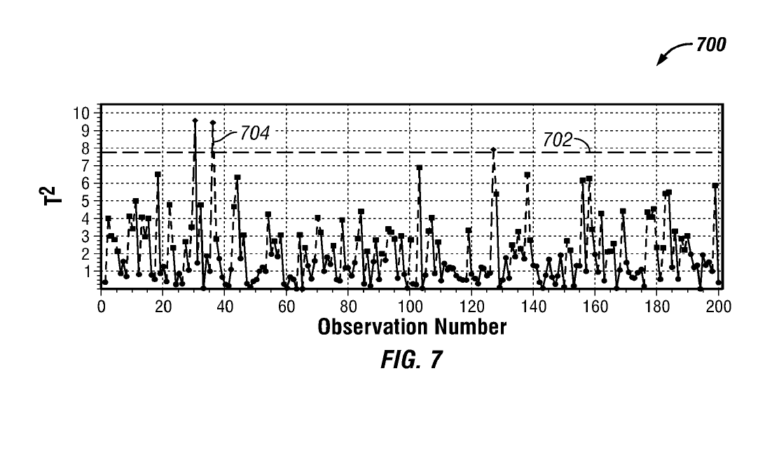

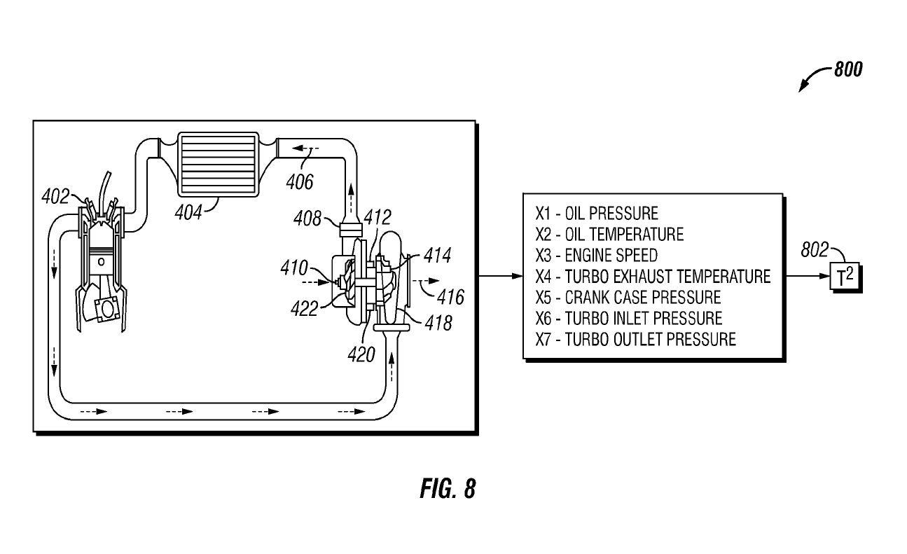

Referencing FIG. 7, an example of an MVSPC analysis 700 is provided with illustrative data 704. The upper control limit (UCL) 702 is shown as a solid line intersecting with the Y-axis at a T² value of approximately 7.8. The T² statistic consolidates a multivariate observation, i.e., an observation on many variables, X′=(x₁, x₂, . . . , xₚ) into a single number. More information about the MVSPC can be found in Multivariate Statistical Process Control with Industrial Application (ASA-SIAM Series on Statistics and Applied Probability 9), R. Mason, et al., Society for Industrial Mathematics (2001), the entire contents of which are incorporated by reference into the current application for all purposes. In one example, referencing FIG. 8, the measured parameters X1 . . . X7 are consolidated into a single T² value 802 for analysis.

The following examples are provided to further illustrate certain embodiments of the current application. Examples are provided for illustrative purposes only, and should not be construed as limitations of the current application.

### Example 1

### Relationship Analysis

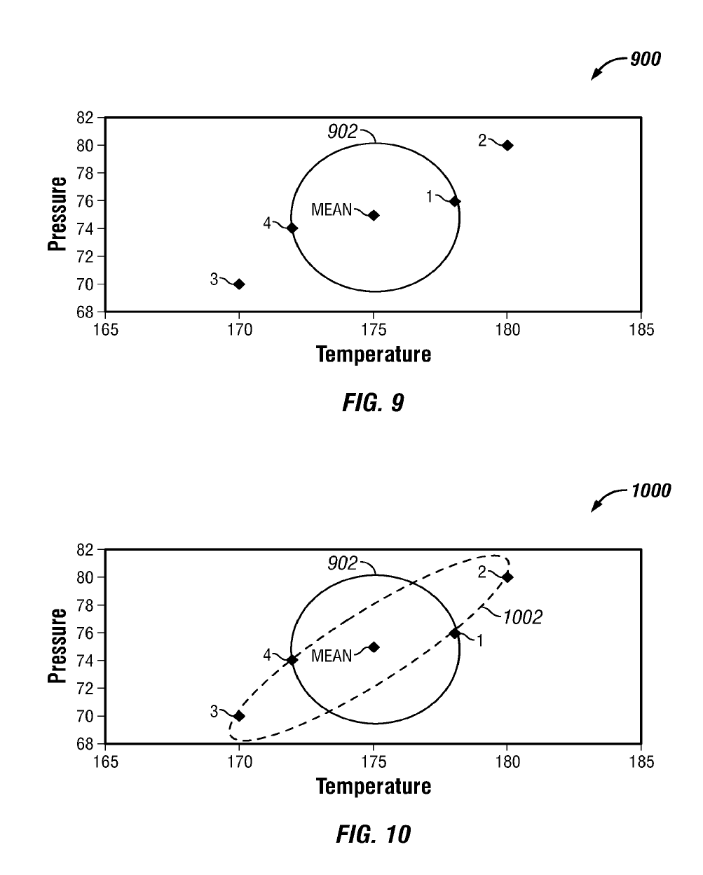

Referencing FIG. 9, illustrative data 900 is provided wherein four (4) readings were taken from the temperature and pressure sensors of a unit of oilfield equipment. The first data point reads 178° F., 76 psi; the second data point, 180° F., 80 psi; the third data point, 170° F., 70 psi; and the 4th data point, 172° F., 74 psi. The mean values of the 4 data points are 175° F., 75 psi. Comparing these data points with each other and calculating the distance each point is from the mean, we obtain the following numbers: first data point=3.16, second data point=7.07, third data point=7.07, and the fourth data point=3.16. These values are plotted in FIG. 9 against a Euclidean distance 902. Relative to the Euclidean distance 902, data points 1 and 4 are closest to the mean and data point 3 is farthest from the mean.

However, the analysis presented in FIG. 9 has not taken into consideration of the distributions of the temperature and pressure to present a mean representative of the data set. Such information is contained in the data presented above, and can be determined by a calculation of the covariance matrix, which defines the interrelationships between variables. The result is shown in the illustrative data 1000 of FIG. 10, which includes the MD 1002 overlaid on the Euclidean distance 902.

### Example 2

### Fluid Analysis Machine

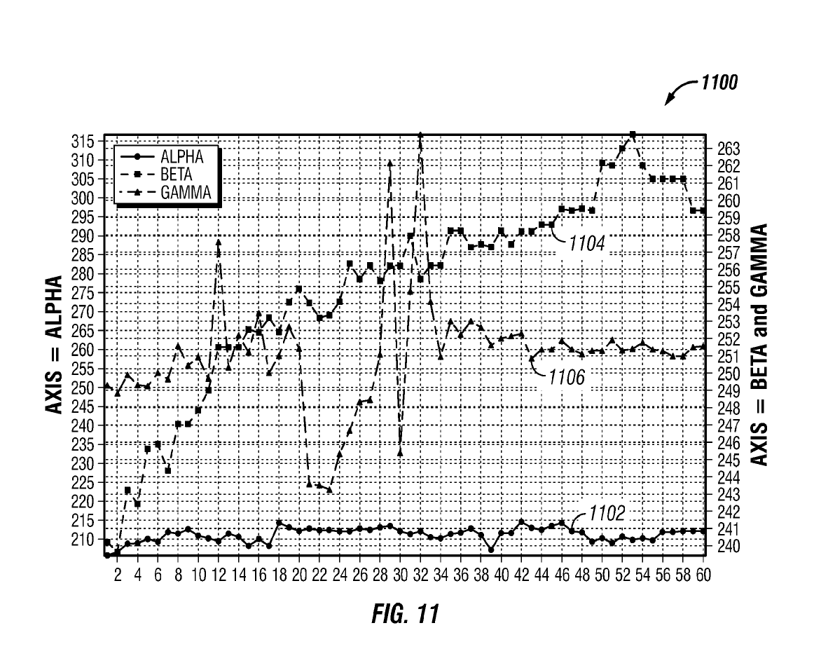

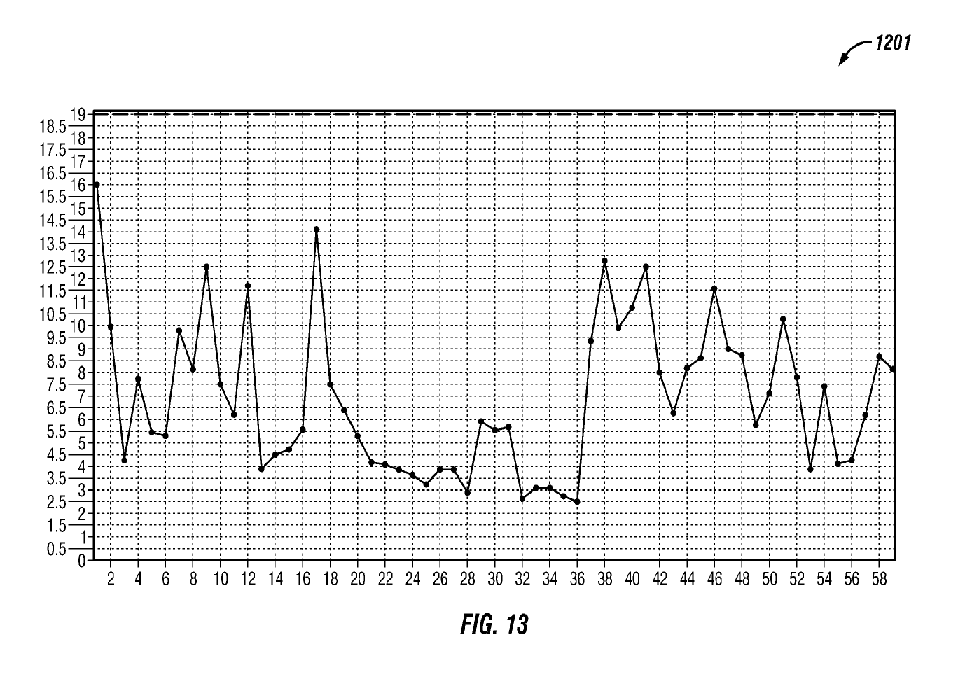

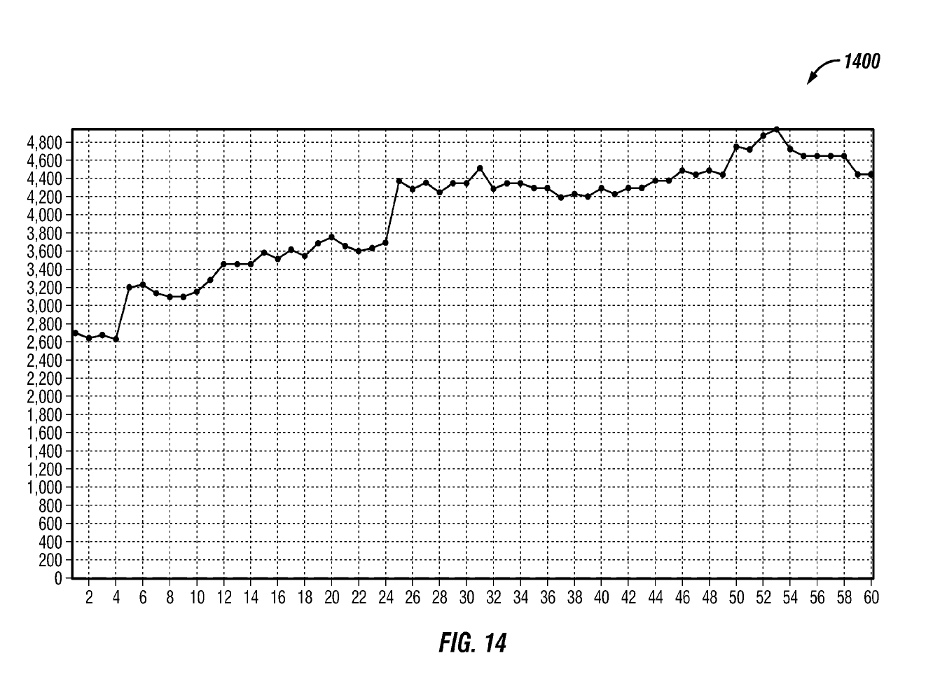

An exemplary embodiment of the current application includes utilizing MVSPC to check the accuracy of three fluid analysis machines. For the ease of reference, the three fluid analysis machines are referenced ALPHA, BETA, and GAMMA. Seven parameters were collected for analysis: cell temperature, flow rate, down stream, up stream, flow stream, permeability, and conductivity. The results are illustrated in FIGS. 11 through 15.

Referencing FIG. 11, the average permeability (Y-axis) of each fluid analysis machine is plotted against the time frame (X-axis) of measurement. ALPHA 1102 was proven to be the most stable machine, because the permeability readings were consistently at a level between 205-215. BETA 1104 and GAMMA 1106 show indications of potential abnormalities. The permeability readings of BETA 1104 showed a steady increase from around 210 to about 300. For GAMMA 1106, the permeability readings fluctuated greatly around time frame 10-14 and again around time frame 20-34. Certain abnormalities can be inferred for BETA 1104 and GAMMA 1106.

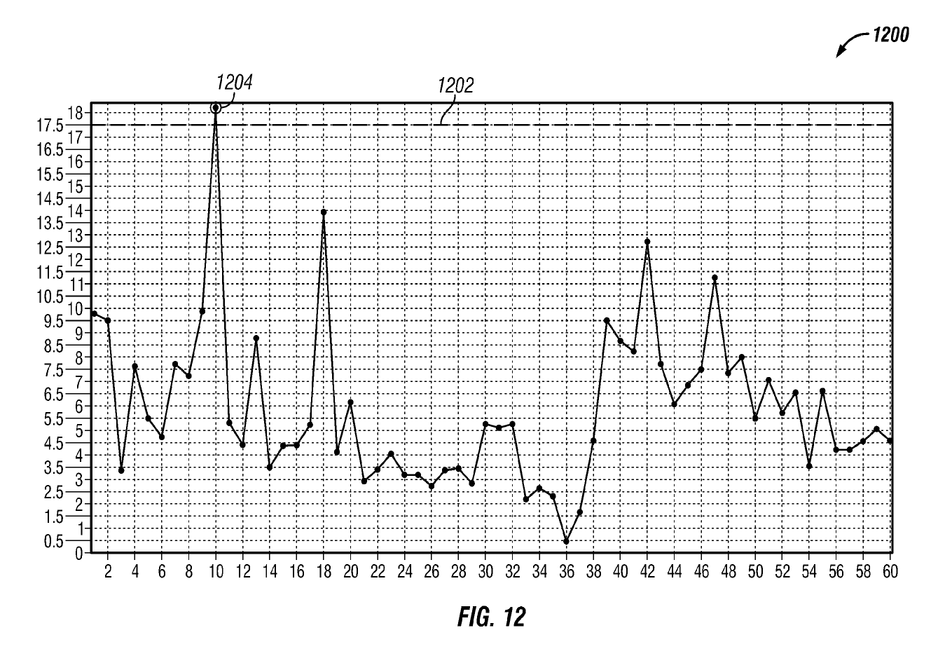

Referencing FIG. 12, illustrative data 1200 shows the T² values of ALPHA (X-axis) against the time frame of measurement (Y-axis). The T² values were calculated by taking into consideration of all seven parameters. For ALPHA, the most stable machine according to the permeability data as shown in the preceding figure, the T² values varied between about 0 to about 18. At time unit 10, an outlier 1204 indicates a T² value for ALPHA that is above the UCL 1202 defined at about 17.5. The outlier 1204 is likely contributed by a measurement error, and in certain embodiments, the single data point at time frame 10 may be eliminated from consideration. The elimination of the outlier 1204 may be determine by an administrator monitoring the system, and/or by an automatic process (e.g. filtering, de-bouncing, providing for a moving average, etc.). Referencing FIG. 9, illustrative data 1201 with the outlier 1204 removed is shown. The manual or automatic removal of measurement errors is an optional step in the operation of the prognostic health management system. Because the T² values of an abnormal unit of equipment are often tens or hundreds times bigger than the T² values of a baseline unit of equipment, it is often not necessary to remove reading errors from the baseline promulgation of the prognostic health management system.

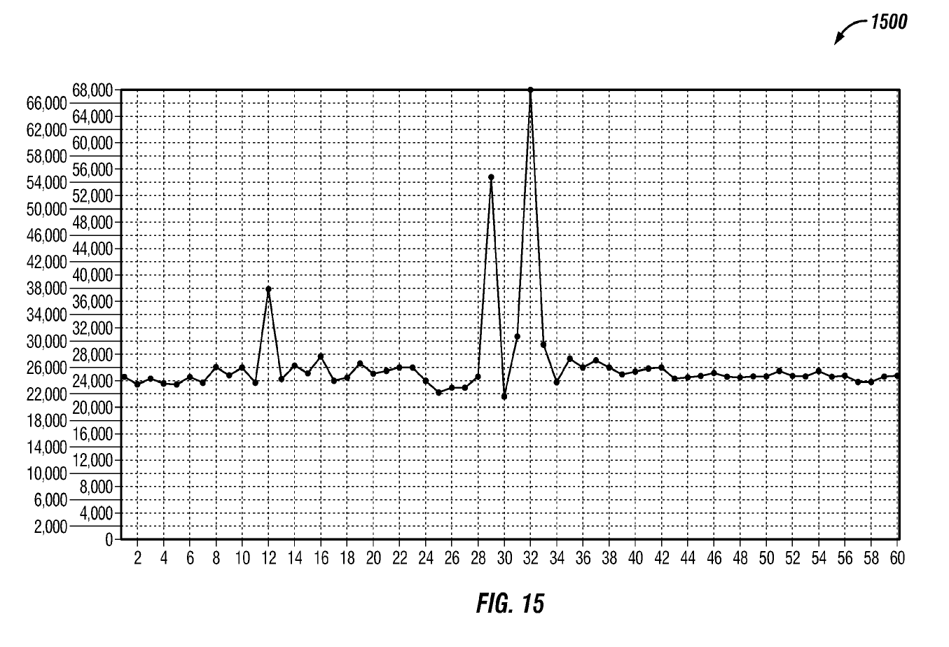

In certain embodiments, once the baseline is constructed, which may be formulated from many properly operating units of equipment, the T² values of the abnormal machines can be calculated and compared with those of the normal machine. In the current example, both BETA and GAMMA showed significantly higher T² values. Referencing FIG. 14, the illustrative data 1400 showing the T² values for BETA, the T² values are in the range of 2600 to 4800. Referencing FIG. 15, the illustrative data 1500 showing the T² values for GAMMA, the T² values are around 24,000 with spikes reaching 58,000.

### Example 3

### Oilfield Pumps

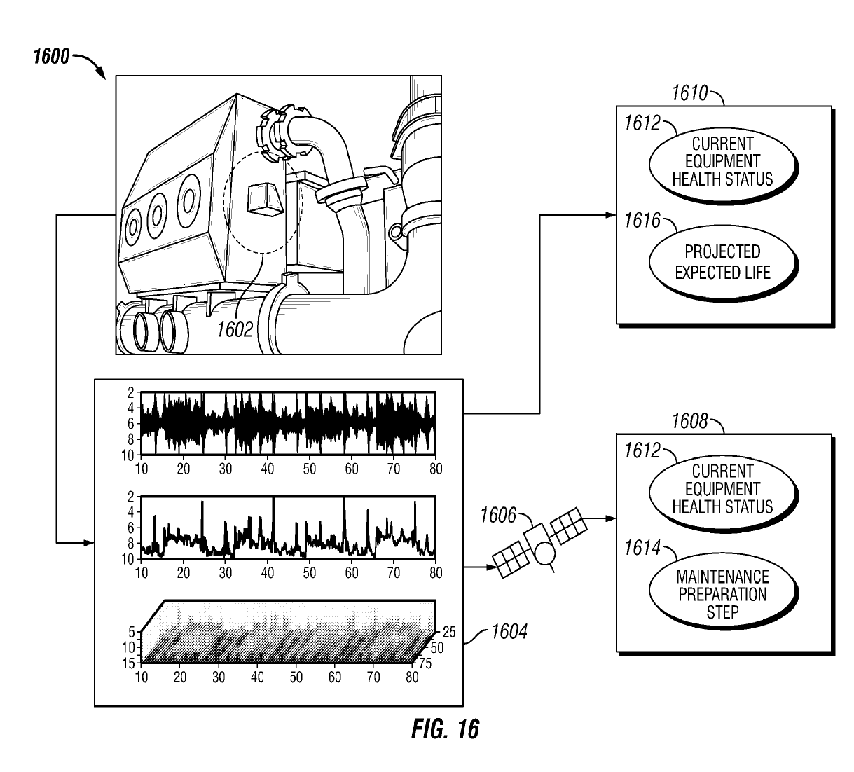

Referencing FIG. 16, a system 1600 uses a knowledge-based system to accelerate the process/equipment faults detection and classification, and uses advanced statistical techniques to monitor the health condition of the equipment and identify abnormalities. Data 1604 from a plurality of sensor channels (e.g. an accelerometer 1602) correlated to pump failures and normal pump operation are determined. According to a multivariate analysis, an exemplary data set 1610 is provided to an operator, the data including a current equipment health status 1612 (e.g. GOOD, FAILED, SUSPECT, etc.) and a projected expected life 1616 (e.g. hours to failure, hours to required maintenance, etc.). Another exemplary data set 1608 may further be provided by a remote communication device 1606, for example conveyed to maintenance personnel. The exemplary data set 1608 includes the current equipment health status 1612 and a maintenance preparation step 1614. The maintenance preparation step 1614 may include a need for repair/maintenance, an indicator that repair/maintenance is upcoming, an indication to deliver maintenance parts to a subsequent location for the pump, an indication to deliver a replacement pump to the subsequent location for the pump, and/or other maintenance communication known in the art.

The described data sets 1608, 1610 are exemplary and non-limiting. Other data sets from a multivariate analysis may be determined and provided by any means understood in the art. In one example, information from operational parameters gathered from the oilfield equipment is combined with oilfield equipment performance parameters to provide optimum maintenance needs. Automated data analysis provides statistical real time data evaluation to provide current equipment health status and projected expected life.

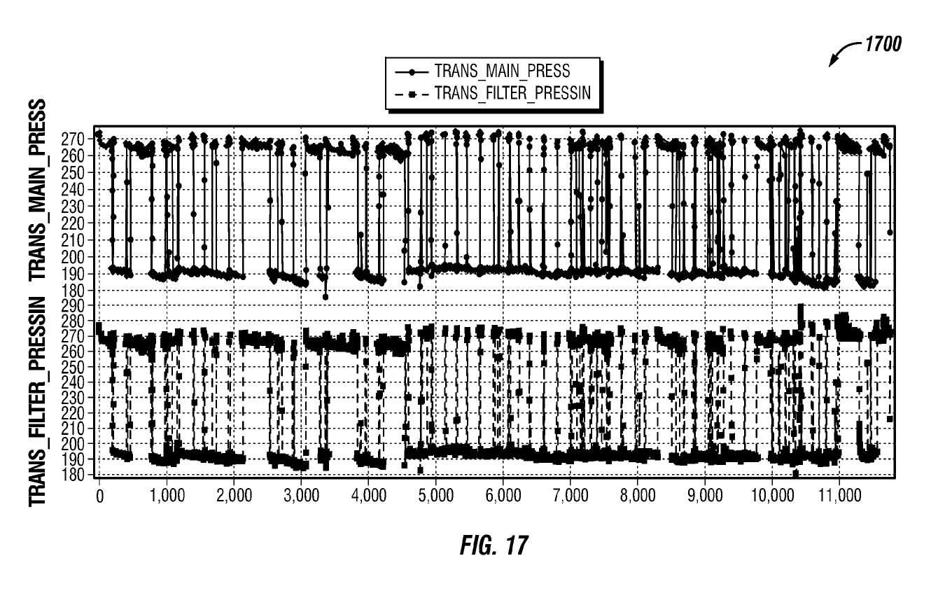

Referencing FIG. 17, illustrative data 1700 shows readings from two pressure sensors from an oilfield pump for a period of 200 hours of pumping. Both readings oscillated between 280 psi and 190 psi, and the manner of oscillation remained consistent throughout the period. By basing a preventive system on the viewing of the single variables alone no conclusion could be drawn and the component of the oilfield equipment in question would be run until failure. The two sensors were chosen as examples for illustrative purposes only. At the time of operation, multiple sensors (in some cases, as many as 20-50 sensors) could be functioning simultaneously. Readings from the sensors can be taken periodically, such as every second, or every five seconds. In the current example, the readings were taken once every minute. All readings so collected were fed into a storage device, such as a hard drive or temporary memory, for storing. The analysis unit, such as a computer, then performed statistical analyses on the data.

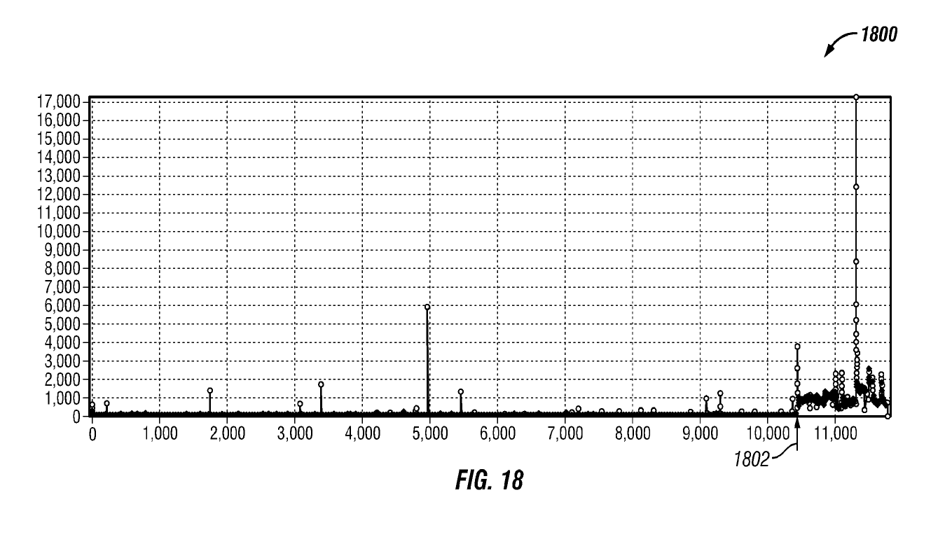

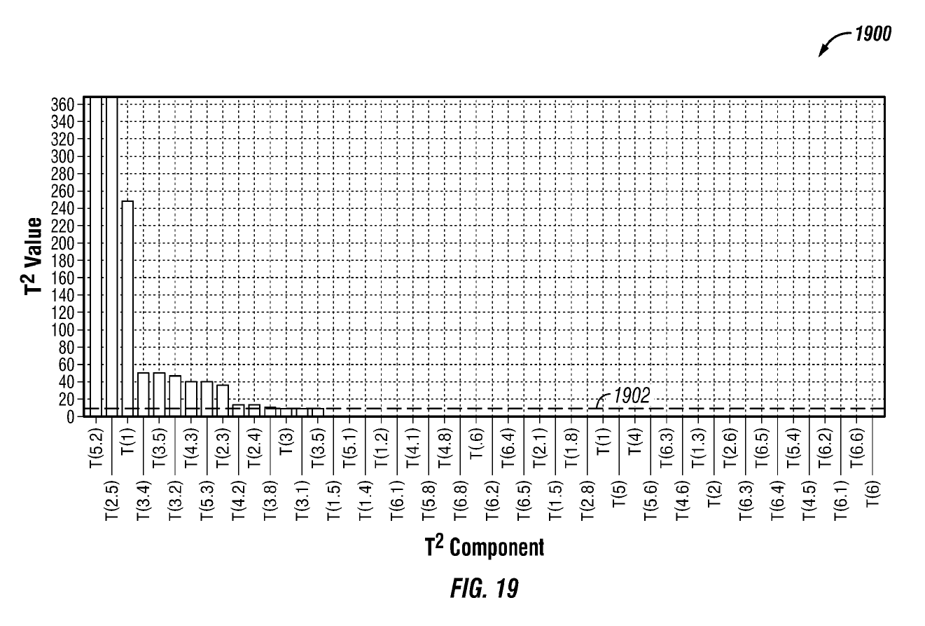

Referencing FIG. 18, illustrative data 1800 shows a T² analysis of historical data versus a good baseline from the same equipment based on a number of sensors. The T² analysis indicates that around time 1802 (about 10,500 minutes), a statistical shift in the data occurs. Referencing FIG. 19, a signal decomposition 1900 of the data from FIG. 18 is shown. A Pareto analysis indicates the key sensor readings driving the divergence. An exemplary baseline significance value 1902 indicates that about 12 sensors describe almost all of the statistical deviation, and those sensors can be utilized in the T² analysis. The determination of the most significant sensors can be determined by any method understood in the art, including at least selecting sensors above a selected significance threshold 1902, and selecting sensors such that a predetermined total significance is explained by the selected sensors (e.g. typically 90% of the variance).

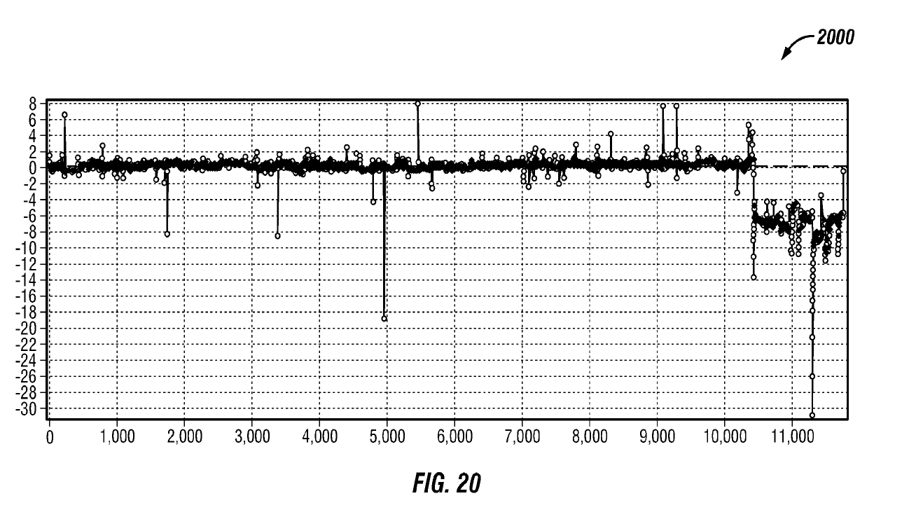

Referencing FIG. 20, illustrative data 2000 shows the unsquared component analysis of the variation utilizing the most significant sensors. Data such as that illustrated in FIG. 20 allows the operator to determine the variance and create a severity matrix that allows the operator to maintain the maintenance operations up to date with the status of the equipment. At the same time, an automatic system can be triggered for immediate actions if the severity level calls upon it to act. Further, the data such as that illustrated in FIGS. 19 and 20 allows the operator to maintain the maintenance operations with a most significant subset of the total number of sensors in the system.

The system of the current application can be applied to both land operations and offshore operations. Land operations have an advantage, since the availability of mechanics and electronic technicians is relatively high in comparison to offshore unit establishments. In any event, wireless or satellite transmission of the data can be utilized to ensure data capture and evaluation.

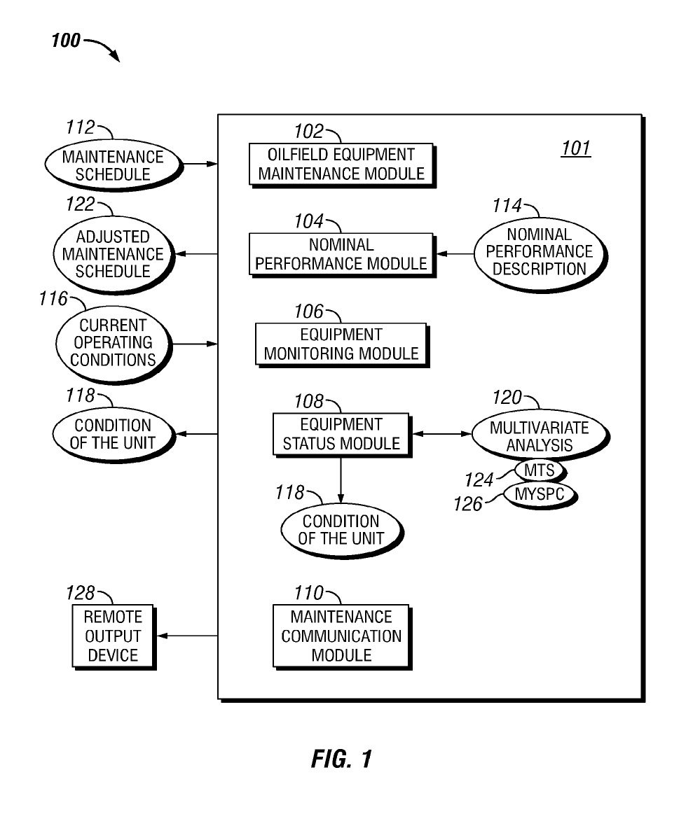

Certain exemplary embodiments are described following. Referencing FIG. 1, a system 100 includes a controller 101 structured to perform certain operations to adjust an equipment maintenance schedule. In certain embodiments, the controller 101 forms a portion of a processing subsystem including one or more computing devices having memory, processing, and communication hardware. The controller 101 may be a single device or a distributed device, and the functions of the controller 101 may be performed by hardware or software.

In certain embodiments, the controller 101 includes one or more modules structured to functionally execute the operations of the controller. In certain embodiments, the controller includes an oilfield equipment maintenance module 102, a nominal performance module 104, an equipment monitoring module 106, an equipment status module 108, and/or a maintenance communication module 110. The description herein including modules emphasizes the structural independence of the aspects of the controller 101, and illustrates one grouping of operations and responsibilities of the controller 101. Other groupings that execute similar overall operations are understood within the scope of the present application. Modules may be implemented in hardware and/or software on computer readable medium, and modules may be distributed across various hardware or software components.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the interpreted parameter can be calculated, and/or by referencing a default value that is interpreted to be the parameter value.

The exemplary controller 101 includes an oilfield equipment maintenance module 102 that interprets a maintenance schedule 112 for a unit of oilfield equipment. The maintenance schedule 112 may be any type of maintenance appropriate for the type of the equipment, including packing of seals, replacement of valves, re-calibration of sensors or other analysis devices, or the like. The maintenance schedule 112 may be provided, without limitation, by a manufacturer, a schedule according to a standards or best practices guide, a schedule determined according to previous experience, and/or a schedule stored from a previous execution cycle of the controller 101.

The exemplary controller 101 further includes a nominal performance module 104 that interprets a nominal performance description 114 for the unit of oilfield equipment. In certain embodiments, the nominal performance description 114 may be provided from prior good operational data 506, from a good historical data set 510, defined by an operator, and/or determined from a previous execution cycle of the controller 101 from the current operating conditions 116 of a unit of equipment that is known to be operating properly.

The exemplary controller 101 further includes an equipment monitoring module 106 that determines a number of current operating conditions 116 of the unit of oilfield equipment. The current operating conditions 116 are selected from available sensors and other parameters in the system, and may be determined in one example from the type of analysis utilized in the section referencing FIGS. 17-20, and/or from sensors and parameters that are known (or believed) to correlate to proper operation of the unit of equipment.

The exemplary controller 101 further includes an equipment status module 108 that determines a condition of the unit of oilfield equipment in response to the nominal performance description 114 and the number of current operating conditions 116 using a multivariate analysis 120. Exemplary and non-limiting multivariate analyses 120 include a Mahalanobis-Taguchi System analysis 124 and/or a multivariate statistical process control analysis 126. In certain embodiments, the oilfield equipment maintenance module 102 adjusts the maintenance schedule 122 for the unit of oilfield equipment in response to the condition of the unit of oilfield equipment. The adjusted maintenance schedule 122 may be stored on the controller 101 for future reference and/or communicated to an operator or output device. In certain further embodiments, the controller 101 includes a maintenance communication module 110 that provides the adjusted maintenance schedule 122 to a remote output device 128. The remote output device 128 may be any device understood in the art, including at least a monitor, a printer, a network or datalink, a wireless communication device, and/or a satellite communication.

Certain non-limiting examples of a unit of oilfield equipment include a high pressure pump (e.g. a positive displacement pump), a low pressure pump, a metering pump, a fluid analysis device, a pressure sensor, a valve, a tubular, a coiled tubing unit, a solids metering device, and/or a well logging device. Any other unit of oilfield equipment having a wear, usage, detection, or failure parameter that is at least partially correlatable to a sensor output value is contemplated herein. In certain embodiments, the oilfield equipment maintenance module adjusts the maintenance schedule by rescheduling a planned maintenance event.

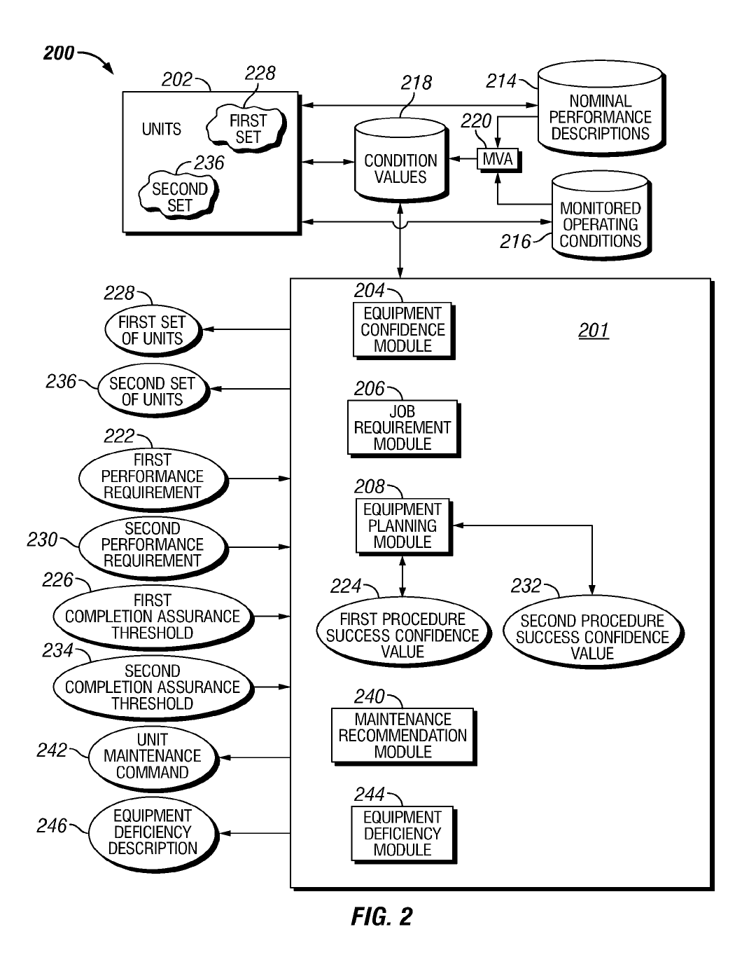

Referencing FIG. 2, yet another exemplary system 200 including a controller 201 is illustrated. The system 200 includes a number of units of oilfield equipment 202, the units of oilfield equipment 202 being of a common equipment type. For example, the units 202 may be pumps, fluid analysis devices, valves, tubular, pressure sensors, or any other type of oilfield equipment wherein a number of the same type of unit may be utilized in a single procedure. The system 200 further includes a controller 201 structured to functionally execute operations for determining an improved asset utilization.

The exemplary controller 201 includes an equipment confidence module 204 that interprets conditions values 218 that include a condition value corresponding to each of the units 202 of oilfield equipment. In certain embodiments, the condition values 218 are determined from a multivariate analysis 220, where the multivariate analysis 220 includes comparing nominal performance descriptions 214 corresponding to each of the units 202, and monitored operating conditions 216 for each of the units 202. The multivariate analysis 220 may be determined according to any of the principles described throughout the present application. The nominal performance descriptions 214 need not be the same for each unit—for example and without limitation the nominal performance description 214 for a 1200 kW fracturing pump would likely have a distinct nominal performance description 214 from a 1500 kW fracturing pump. However, both pumps have a power rating and a condition value 218 communicable to the controller 201.

The exemplary controller 201 further includes a job requirement module 206 that interprets a performance requirement 222 (e.g. a first performance requirement) for an oilfield procedure. Exemplary performance requirements 222 include a pump schedule, a pressure and time of operation, and/or any other parameters appropriate to the units 202 wherein a comparison can be made to determine according to the condition values 218 whether a particular one of the units is likely to be able to contribute to the procedure for the duration and expected conditions of the procedure.

The exemplary controller 201 further includes an equipment planning module 208 that selects a set of units (e.g. a first set 228 of the units) from the units 202 of oilfield equipment in response to the performance requirement 222 for the oilfield procedure and the condition values 218 corresponding to each of the units of oilfield equipment, such that a procedure success confidence value 224 exceeds a completion assurance threshold 226. In one example, the completion assurance threshold 226 is a statistical description of the acceptable likelihood that the procedure will be successfully completed. For example, if the performance requirement 222 is for 30 bpm of fluid delivery at 5,000 psi for 30 minutes, the units 202 are pumps, and the completion assurance threshold 226 is a 97% chance of procedure, the equipment planning module 208 selects a sufficient number of pumps having sufficient condition values 218 such that the procedure success confidence value 224 exceeds the 97% value. In the example if each of the units delivers 6 bpm for the pressure and duration at a 90% confidence level, then 7 pumps are required to put the procedure success confidence value about 97.5%. The completion assurance threshold 226 may be an operator defined value, a value read from a datalink or network, a predetermined value stored on the controller 201, and/or a default value in the system 200.

In certain embodiments, the units 202 are positive displacement pumps. In certain further embodiments, the performance requirement 222 includes a pumping rate, a pumping rate at a predetermined pressure, and/or a pumping power requirement. An exemplary system includes the job requirement module 206 interpreting a first performance requirement 222 and a second performance requirement 230, and the equipment planning module 208 further selecting a first set of units 228 and a second set of units 236 from the total number of units 202 such that the first procedure success confidence value 224 exceeds the first completion assurance threshold 226 for the first performance requirement 222, and a second procedure success confidence value 232 exceeds a second procedure assurance threshold 234 for a second performance requirement 230. Accordingly, the equipment planning module 208 can select enough of the units 202 having sufficient confidence based on the condition values 218 such that multiple performance requirements 222, 230 may be met.

In one example, the units 202 are pumps, the first performance requirement 222 is 30 bpm at 5,000 psi for 30 minutes and the first completion assurance threshold 226 is a 97% assurance value. Further in the example, the second performance requirement 230 is 18 bpm at 12,000 psi for 30 minutes, and the second completion assurance threshold 234 is 90%. The exemplary equipment planning module 208 selects from the available units 202 to provide a first set of units 228 and a second set of units 236 such that the first procedure success confidence value 224 exceeds 97% and the second procedure success confidence value 232 exceeds 90%. In the example, the units 202 include 10 pumps each having a 90% confidence level to complete the first procedure at 6 bpm (pump group A), and a 65% confidence level to complete the second procedure at 4 bpm, and the units 202 further include 6 pumps each having a 99% confidence level to complete the first procedure at 5 bpm (pump group B), and a 90% confidence to complete the second procedure at 3.5 bpm. An exemplary equipment planning module 208 selects 7 of the group A pumps for the first procedure (97.5% confidence) and the remaining pumps (6 from group B and the remaining 3 from group A—about 94.5% confidence).

It is noted that, in a typical default situation where all of the high confidence pumps are selected for the first procedure (e.g. this is the first job called in), the 6 group B pumps would be selected (94.5% confidence for the first procedure), requiring 1 additional group A pump to achieve the first procedure (then at 99% confidence). The remaining 9 group A pumps would then be insufficient to acceptably perform the second procedure, having only about an 82.5% second procedure success confidence value 232. Accordingly, the operations of the controller 201 can achieve greater asset utilization in response to the condition values 218.

In certain embodiments, the controller 201 further includes a maintenance recommendation module 240 that provides a unit maintenance command 242 in response to determining that no set of units 228 from the total number of units 202 is sufficient to provide a procedure success confidence value 224 that exceeds the completion assurance threshold 226. For example, if one or more of the units has a condition value 218 providing for a low confidence value (but not necessarily a FAILED value), where the one or more units having a more normal or more optimal confidence value would provide a sufficient procedure success confidence value 224, the maintenance recommendation module 240 may flag the one or more units with a unit maintenance command 242. In certain embodiments, the unit maintenance command 242 may further indicate that the procedure could be completed if the maintenance of the unit maintenance command 242 is performed. In certain embodiments, the unit maintenance command 242 includes a maintenance instruction corresponding to at least one of the units 202. In certain embodiments, the unit maintenance command 242 includes a maintenance instruction corresponding to one or more of the units having a condition value 218 that is not an abnormal condition value, but that nevertheless may be improved through a maintenance operation such that one or more procedures may be acceptably performed with the units 202. An exemplary unit maintenance command 242 may be provided for the second procedure where a first set of units 228 is available for the first procedure.

In certain embodiments, the controller 201 includes an equipment deficiency module 244 that provides an equipment deficiency description 246 in response to determining that no set of units 228 from the total number of units 202 is sufficient to provide a procedure success confidence value 224 that exceeds the completion assurance threshold 226. The exemplary equipment deficiency module 244 may operate independently of the maintenance recommendation module 240—for example providing an equipment deficiency description 246 even if an appropriate maintenance action can otherwise enable the units 202 or a subset of the units 202 to acceptably perform the one or more procedures. In certain embodiments, the equipment deficiency module 244 provides the equipment deficiency description 246 only in response to there being no unit maintenance command 242 available to enable the units 202 or a subset of the units 202 to acceptably perform the one or more procedures. The equipment deficiency description 246 includes, in certain embodiments, the additional units or unit capability that would be required to acceptably perform the one or more procedures. An exemplary equipment deficiency description 246 may be provided for the second procedure where a first set of units 228 is available for the first procedure.

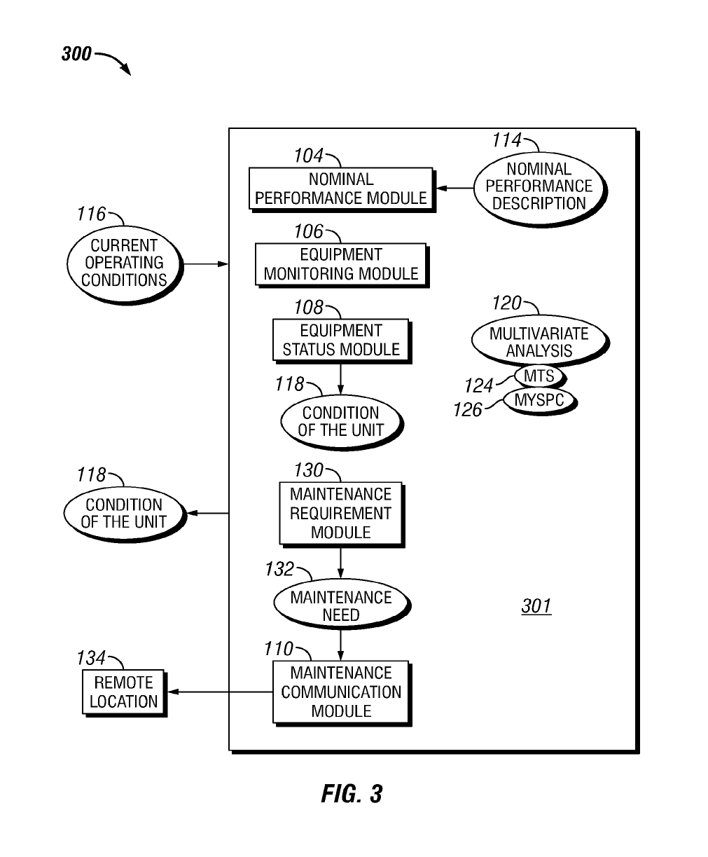

Yet another exemplary system 300 is described in reference to FIG. 3. The system includes a controller 310 having a nominal performance module 104 that interprets a nominal performance description 114 for a unit of oilfield equipment, and an equipment monitoring module 106 that determines a number of operating conditions for the unit of oilfield equipment. The controller 301 further includes an equipment status module 108 that performs a multivariate analysis 120 to determine a condition of the unit 118, and a maintenance requirement module 130 that determines a maintenance need 132 for the unit in response to the condition of the unit 118. The exemplary controller 301 further includes a maintenance communication module 110 that communicates the maintenance need 132 to a remote location 134.

The schematic flow descriptions which follow provides illustrative embodiments of performing procedures for updating a maintenance schedule, improving asset utilization, and performing a maintenance preparation step. Operations described are understood to be exemplary only, and operations may be combined or divided, and added or removed, as well as re-ordered in whole or part, unless stated explicitly to the contrary herein. Certain operations described may be implemented by a computer executing a computer program product on a computer readable medium, where the computer program product comprises instructions causing the computer to execute one or more of the operations, or to issue commands to other devices to execute one or more of the operations.

An exemplary procedure for updating a maintenance schedule includes an operation to interpret a maintenance schedule for a unit of oilfield equipment, an operation to interpret a nominal performance description for the unit of oilfield equipment, and an operation to determine a number of current operating conditions for the unit of oilfield equipment. The procedure further includes an operation to determine a condition of the unit of oilfield equipment in response to the nominal performance description and the current operating conditions using a multivariate analysis. In certain embodiments, the procedure includes an operation to adjust the maintenance schedule for the unit of oilfield equipment in response of the condition of the unit of oilfield equipment.

Certain further embodiments of the procedure are described following. An exemplary procedure further includes the oilfield equipment being selected from the units consisting of a high pressure pump, a low pressure pump, a metering pump, a fluid analysis device, a pressure sensor, a valve, a tubular, a coiled tubing unit, a solids metering device, and/or a well logging device. An exemplary procedure further includes adjusting the maintenance schedule by rescheduling a planned maintenance event. Another exemplary embodiment includes an operation to provide the adjusted maintenance schedule to a remote output device. In certain embodiments, the multivariate analysis includes a Mahalanobis-Taguchi System analysis and/or a multivariate statistical process control analysis.

Yet another exemplary procedure for improving asset utilization includes an operation to interpret a condition value corresponding to each of a number of units of oilfield equipment, and an operation to interpret a performance requirement for one or more oilfield procedures. The procedure includes selecting a set of units from the number of units of oilfield equipment for each of the oilfield procedures. Each set of units from the number of units of oilfield equipment is selected such that a procedure success confidence value corresponding to the procedure exceeds a completion assurance threshold for the procedure. The procedure success confidence value is determined in response to the condition values and the performance requirements.

Further exemplary operations of a procedure for improving asset utilization are described following. An exemplary procedure includes determining each condition value from a multivariate analysis including comparing a nominal performance description for each unit with a number of operating conditions monitored for the unit. Another exemplary procedure includes the units of oilfield equipment being positive displacement pumps. In a further embodiment, the performance requirement for each procedure includes a pumping rate, a pumping rate at a predetermined pressure, and/or a pumping power requirement. An exemplary procedure includes two or more performance requirements, each performance requirement corresponding to a distinct oilfield procedure.

Yet another exemplary embodiment includes an operation to provide a unit maintenance command in response to determining that no set of units from the number of units is sufficient to provide a procedure success value for one or more of the oilfield procedures that exceeds the completion assurance threshold for the one or more of the oilfield procedures. A further embodiment includes providing the unit maintenance command as a maintenance instruction corresponding to one or more of the units. In certain embodiments, the unit maintenance command is a command which, if performed, makes a set of units available that is sufficient to provide the procedure success value for the one or more of the oilfield procedures that exceeds the completion assurance threshold for the one or more of the oilfield procedures. In certain further embodiments, the unit maintenance command is directed to a unit having a condition value that is not an abnormal condition value.

In certain further embodiments, the procedure further includes an operation to provide an equipment deficiency description in response to determining that no set of units from the number of units is sufficient to provide a procedure success value for one or more of the oilfield procedures that exceeds the completion assurance threshold for the one or more of the oilfield procedures.

Yet another exemplary procedure, for performing a maintenance preparation step, includes an operation to interpret a nominal performance description for a unit of oilfield equipment, and an operation to determine a number of operating conditions for the unit of oilfield equipment. The procedure further includes an operation to perform a multivariate analysis to determine a condition of the unit of oilfield equipment in response to the nominal description and the operating conditions. The exemplary procedure further includes an operation to determine a maintenance need for the unit in response to the condition of the unit, and an operation to communicate the maintenance need for the unit to a remote location. The procedure further includes, in response to the communicating, an operation to perform a maintenance preparation step.

In certain embodiments, the maintenance need is communicated, and the maintenance preparation step is performed, when a condition of the unit is not abnormal. For example, when the unit is near minimally conforming, and it is determined that a subsequent procedure has a high likelihood of the unit becoming non-conforming, and/or when it is desirable that a confidence level of the unit be increased such that a subsequent procedure success confidence value can be increased to achieve a completion assurance threshold, a conforming unit may nevertheless have the maintenance need communicated. Exemplary operation to perform the maintenance preparation step include ordering specified parts for the unit, providing specified parts for the unit to a future planned location for the unit (e.g. the location of a subsequent procedure), and/or sending a replacement unit to the future planned location for the unit.

As is evident from the figures and text presented above, a variety of embodiments of the presented concepts are contemplated.

An exemplary set of embodiments is an apparatus including an oilfield equipment maintenance module that interprets a maintenance schedule for a unit of oilfield equipment, a nominal performance module that interprets a nominal performance description for the unit of oilfield equipment, and an equipment monitoring module that determines a number of current operating conditions of the unit of oilfield equipment. The apparatus includes an equipment status module that determines a condition of the unit of oilfield equipment in response to the nominal performance description and the number of current operating conditions using a multivariate analysis, where the oilfield equipment maintenance module adjusts the maintenance schedule for the unit of oilfield equipment in response to the condition of the unit of oilfield equipment.

Certain further exemplary embodiments of the apparatus are described following. An exemplary apparatus includes the unit of oilfield equipment being a high pressure pump, a low pressure pump, a metering pump, a fluid analysis device, a pressure sensor, a valve, a tubular, a coiled tubing unit, a solids metering device, and/or a well logging device. An exemplary apparatus includes the oilfield equipment maintenance module further adjusting the maintenance schedule by rescheduling a planned maintenance event. An exemplary apparatus further includes a maintenance communication module providing the adjusted maintenance schedule to a remote output device. In certain embodiments, the multivariate analysis includes of a Mahalanobis-Taguchi System analysis and/or a multivariate statistical process control analysis.

Yet another exemplary set of embodiments is a system including a number of units of oilfield equipment, where the units of oilfield equipment are of a common equipment type. The system further includes a controller having an equipment confidence module that interprets a condition value corresponding to each of the units of oilfield equipment, a job requirement module that interprets a performance requirement for an oilfield procedure, and an equipment planning module that selects a set of units from the total number of units of oilfield equipment in response to the performance requirement for the oilfield procedure and the condition value corresponding to each of the units of oilfield equipment, such that a procedure success confidence value exceeds a completion assurance threshold.

Certain further exemplary embodiments of the system are described following. An exemplary system includes each condition value determined from a multivariate analysis including, for each of the units of equipment, comparing a nominal performance description corresponding to the unit of equipment to a number of operating conditions monitored for the unit of equipment. In certain embodiments, the units of equipment are positive displacement pumps. In certain further embodiments, the performance requirement includes a pumping rate, a pumping rate at a predetermined pressure, and/or a pumping power requirement.

An exemplary system further includes the performance requirement being a first performance requirement for a first oilfield procedure, the set of units being a first set of units, the procedure success confidence value being first procedure confidence value, and the completion assurance value being first completion assurance value. The exemplary system further includes the job requirements module further interpreting a second performance requirement for a second oilfield procedure, and the equipment planning module further selecting the first set of units and a second set of units from the total number of units in response to the first performance requirement, the second performance requirement, and the condition value corresponding to each of the units of oilfield equipment. The equipment planning module selects the first set of units and the second set of units such that the first procedure success confidence value exceeds the first completion assurance threshold and a second procedure success confidence value exceeds a second procedure assurance threshold.

In certain embodiments, the system includes a maintenance recommendation module that provides a unit maintenance command in response to determining that no set of units from the plurality of units is sufficient to provide a procedure success value that exceeds the completion assurance threshold, where the unit maintenance command comprising a maintenance instruction corresponding to at least one of the units. Another exemplary system includes the maintenance instruction corresponding to at least one of the units having a condition value that is not an abnormal condition value. Yet another exemplary system includes an equipment deficiency module that provides an equipment deficiency description in response to determining that no set of units from the total number of units is sufficient to provide a procedure success value that exceeds the completion assurance threshold.

Still another exemplary set of embodiments is a method for performing a maintenance preparation step. The exemplary method includes interpreting a nominal performance description for a unit of oilfield equipment, determining a number of operating conditions for the unit of oilfield equipment, and performing a multivariate analysis to determine a condition of the unit of oilfield equipment in response to the nominal description and the operating conditions. The method further includes determining a maintenance need for the unit in response to the condition of the unit, communicating the maintenance need for the unit to a remote location, and in response to the communicating, performing a maintenance preparation step.

Exemplary operations to perform the maintenance preparation step include ordering specified parts for the unit, providing specified parts for the unit to a future planned location for the unit, and/or sending a replacement unit to a future planned location for the unit. In certain embodiments, the condition of the unit is not abnormal.

The preceding description has been presented with reference to some embodiments. Persons skilled in the art and technology to which this disclosure pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Furthermore, none of the descriptions in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of the presented claims are intended to invoke paragraph six of 35 USC §112 unless the exact words “means for” appear, followed by a participle. The claims as filed are intended to be as comprehensive as possible, and NO subject matter is intentionally relinquished, dedicated, or abandoned.

What is claimed is:

1. An apparatus, comprising:
an oilfield equipment maintenance module structured to interpret a maintenance schedule for a unit of oilfield equipment;
a nominal performance module structured to interpret a nominal performance description for the unit of oilfield equipment;
an equipment monitoring module structured to determine a plurality of current operating conditions of the unit of oilfield equipment;
an equipment status module structured to determine a condition of the unit of oilfield equipment in response to the nominal performance description and the plurality of current operating conditions using a multivariate analysis; and
wherein the oilfield equipment maintenance module is further structured to adjust the maintenance schedule for the unit of oilfield equipment in response to the condition of the unit of oilfield equipment.

2. The apparatus of claim 1, wherein the unit of oilfield equipment comprises a unit of equipment selected from the units of equipment consisting of: a high pressure pump, a low pressure pump, a metering pump, a fluid analysis device, a pressure sensor, a valve, a tubular, a coiled tubing unit, a solids metering device, and a well logging device.

3. The apparatus of any one of claims 1 and 2, wherein the oilfield equipment maintenance module is further structured to adjust the maintenance schedule by rescheduling a planned maintenance event.

4. The apparatus of any one of claims 1 through 3, further comprising a maintenance communication module structured to provide the adjusted maintenance schedule to a remote output device.

5. The apparatus of any one of claims 1 through 4, wherein the multivariate analysis comprises one of a Mahalanobis-Taguchi System analysis and a multivariate statistical process control analysis.

6. A system, comprising:
a plurality of units of oilfield equipment, the units of oilfield equipment comprising a common equipment type;
a controller, comprising:
an equipment confidence module structured to interpret a condition value corresponding to each of the units of oilfield equipment;
a job requirement module structured to interpret a performance requirement for an oilfield procedure; and
an equipment planning module structured to select a set of units from the plurality of units of oilfield equipment in response to the performance requirement for the oilfield procedure and the condition value corresponding to each of the units of oilfield equipment, such that a procedure success confidence value exceeds a completion assurance threshold.

7. A system according to claim 6, wherein each condition value is determined from a multivariate analysis comprising, for each of the units of equipment, comparing a nominal performance description corresponding to the unit of equipment to a plurality of operating conditions monitored for the unit of equipment.

8. A system according to one of claims 6 and 7, wherein the units of equipment comprise positive displacement pumps.

9. A system according to claim 8, wherein the performance requirement comprises a requirement selected from the requirements consisting of: a pumping rate, a pumping rate at a predetermined pressure, and a pumping power requirement.

10. A system according to any one of claims 6 through 9:
wherein the performance requirement is a first performance requirement for a first oilfield procedure, wherein the set of units is a first set of units, wherein the procedure success confidence value is a first procedure confidence value, and wherein the completion assurance value is a first completion assurance value; and
wherein the job requirements module is further structured to interpret a second performance requirement for a second oilfield procedure, and wherein the equipment planning module is further structured to select the first set of units and a second set of units from the plurality of units in response to the first performance requirement, the second performance requirement, and the condition value corresponding to each of the units of oilfield equipment, such that the first procedure success confidence value exceeds the first completion assurance threshold and a second procedure success confidence value exceeds a second procedure assurance threshold.

11. The system of any one of claims 6 through 9, further comprising a maintenance recommendation module structured to provide a unit maintenance command in response to determining that no set of units from the plurality of units is sufficient to provide a procedure success value that exceeds the completion assurance threshold, the unit maintenance command comprising a maintenance instruction corresponding to at least one of the units.

12. The system of claim 11, wherein the maintenance instruction corresponds to at least one of the units having a condition value that is not an abnormal condition value.

13. The system of any one of claims 6 through 9, further comprising an equipment deficiency module structured to provide an equipment deficiency description in response to determining that no set of units from the plurality of units is sufficient to provide a procedure success value that exceeds the completion assurance threshold.

14. A method, comprising:
interpreting a nominal performance description for a unit of oilfield equipment;
determining a plurality of operating conditions for the unit of oilfield equipment;
performing a multivariate analysis to determine a condition of the unit of oilfield equipment in response to the nominal description and the operating conditions;
determining a maintenance need for the unit in response to the condition of the unit;
communicating the maintenance need for the unit to a remote location; and
in response to the communicating, performing a maintenance preparation step.

15. The method according to claim 14, wherein performing the maintenance preparation step comprises performing at least one operation selected from the operations consisting of: ordering specified parts for the unit, providing specified parts for the unit to a future planned location for the unit, and sending a replacement unit to a future planned location for the unit.

16. The method of any one of claims 14 and 15, wherein the condition of the unit is not abnormal.
